(19) United States
(12) Patent Application Publication
(10) Pub. No.: US 2025/0174864 A1
(43) Pub. Date: May 29, 2025

(54) FILTER FOR COMMUNICATION DEVICE

(71) Applicant: KMW INC., Hwaseong-si (KR)

(72) Inventors: Joung Hoe KIM, Hwaseong-si (KR); Sang Yoong KIM, Hwaseong-si (KR)

(73) Assignee: KMW INC., Hwaseong-si (KR)

(21) Appl. No.: 19/035,939

(22) Filed: Jan. 24, 2025

Related U.S. Application Data
(63) Continuation of application No. PCT/KR2023/010830, filed on Jul. 26, 2023.

(30) Foreign Application Priority Data
Jul. 27, 2022 (KR) 10-2022-0092887
Jul. 24, 2023 (KR) 10-2023-0096038

(51) Int. Cl. H01P 1/20

(52) U.S. Cl. CPC H01P 1/2002

(57) ABSTRACT

The present disclosure relates to a filter for a communication device and, more specifically, includes: a filter body that is open in the thickness direction and has formed therein part of a dielectric-filled space; a filter tuning cover that is coupled in the opened thickness direction to cover the filter body and forms the remainder of the dielectric-filled space; a resonance substrate including a resonance frame in which a plurality of resonators are arranged to form a single layer with respect to the thickness direction in the dielectric-filled space; a frequency tuning panel including a tuning frame including a plurality of tuning bars arranged in a single layer in the thickness direction in the dielectric-filled space in order to adjust a separation distance from the plurality of resonators arranged in the dielectric-filled space; and a spacer portion integrally formed with a step on one of the filter tuning cover and the frequency tuning panel.

### TECHNICAL FIELD

The present disclosure relates to a filter for a communication device, and more particularly, to a filter for a communication device that can be manufactured with a slim thickness while achieving weight reduction.

### BACKGROUND ART

A radio frequency device such as a radio frequency filter (including all ‘communication devices’) is usually composed of a connection structure of a plurality of resonators. Such a resonator is a circuit element that resonates at a specific frequency by a combination of an inductor L and a capacitor C in an equivalent electronic circuit, and each resonator has a structure in which a dielectric resonance element (dielectric resonance element (DR)) or a metal resonance element is installed inside a cavity such as a metallic cylinder or rectangular parallelepiped surrounded by a conductor. Accordingly, each resonator has a structure in which only an electromagnetic field of a unique frequency according to a processing frequency band exists in a cavity, thereby enabling high-frequency resonance. Usually, a plurality of resonance stages are formed using a plurality of cavities, and a multi-stage structure in which the plurality of resonance stages are sequentially connected is used.

An example of a radio frequency filter having a plurality of cavity structures is disclosed in Korean Patent Publication No. 10-2004-0100084 (title: “Radio Frequency Filter”, published on Dec. 2, 2004) previously filed by the applicant of the present application.

However, the conventional radio frequency filter is provided so that each resonator extends in a thickness direction within a cavity and a portion of a filter tuning cover covering the cavity is deformed in an engraving manner to have desired bandpass characteristics, thereby tuning the frequency. Therefore, there is a very limited problem in reducing the size of the completed filter in the thickness direction.

In addition, the conventional radio frequency filter is to reinforce skirt characteristics of adjacent resonance periods or spaced resonance periods within a plurality of cavities, and thus require the installation of an additional configuration of a conductive material to implement inductive coupling or capacitive coupling, which also points out the problem that the weight of the completed filter significantly increases.

### DISCLOSURE

### Technical Problem

The present disclosure has been made to solve the above-mentioned technical problem, and an object of the present disclosure is to provide a filter for a communication device including a tuning panel having a plurality of tuning bars disposed as a single layer in a thickness direction within a dielectric material-filled space.

In addition, another object of the present disclosure provides a filter for a communication device capable of performing frequency tuning by adjusting a separation distance between a plurality of resonators of a resonance substrate disposed as a single layer different from a tuning panel in a thickness direction within a dielectric material-filled space.

In addition, still another object of the present disclosure provides a filter for a communication device including a notch forming part formed as a single layer identical to a tuning panel.

However, the technical problems of the present disclosure are not limited to the problems mentioned above, and other technical problems not mentioned will be clearly understood by those skilled in the art from the following description.

### Technical Solution

In one general aspect, a filter for a communication device includes a filter body that is opened in a thickness direction and forms a portion of a dielectric material-filled space therein, a filter tuning cover that is coupled in the thickness direction so as to cover the filter body and forms the rest of the dielectric material-filled space, a resonance substrate that includes resonance frame in which a plurality of resonators are disposed to form a single layer in the thickness direction within the dielectric material-filled space, a frequency tuning panel that includes a tuning frame having a plurality of tuning bar disposed as a single layer in the thickness direction within the dielectric material-filled space to adjust a separation distance between a plurality of resonators disposed within the dielectric material-filled space, and a spacer part that is integrally formed to be stepped with one of the filter tuning cover and the frequency tuning panel.

The spacer part may be provided to secure a separation distance between the plurality of resonators and the plurality of tuning bars.

The spacer part may be formed as a stepped part that is integrally formed with the filter tuning cover and may be formed so that an upper surface of an edge end portion of the frequency tuning panel is stacked at a position higher than a lower edge of the filter tuning cover stacked on an upper surface of the resonance substrate.

The spacer part may include the stepped part so as to form a joint surface where the upper surface of the edge end portion of the frequency tuning panel is joined as a different layer between the upper surface and the lower surface of the filter tuning cover.

An outer side end of the joint surface may be formed at a position corresponding to the edge end of the frequency tuning panel.

A height of the stepped part may be the separation distance between the upper surface of the frequency tuning panel stacked on the dielectric material-filled space and the upper surface of the resonance frame of the resonance substrate.

The upper surface of the edge end portion of the tuning frame and the upper surfaces of the plurality of tuning bars may be formed as a single layer having the same horizontal plane.

The spacer part may be formed as a stepped part that is integrally formed with the frequency tuning panel, and is stepped so that an edge end portion of the frequency tuning panel stacked on an edge upper surface of the resonance substrate may be lower than the plurality of tuning bars.

The stepped part may be formed to be stepped so that the plurality of tuning bars and the tuning frame form different layers.

The end portion of the filter tuning cover may be stacked and joined to the upper surface of the stepped part as the same layer as the plurality of tuning bars.

The height of the stepped part may be the separation distance between the lower surface of the filter tuning cover and the upper surface of the tuning frame.

The filter may further include a plurality of coupling control bars that are integrally formed with a tuning frame of the frequency tuning panel and are shape-deformed in the direction of the dielectric material-filled space to change a coupling value between adjacent resonators among the plurality of resonators.

The plurality of coupling control bars may be alternately disposed with the plurality of resonators in the thickness direction of the dielectric material-filled space.

The plurality of coupling control bars may be formed so as to be arranged alternately with the plurality of tuning bars in a length direction of the tuning frame.

### Advantageous Effects

According to a filter for a communication device according to an embodiment of the present disclosure, the following various effects can be achieved.

First, since a plurality of resonators of a resonance substrate and a plurality of tuning bars of a frequency tuning panel are respectively disposed as different single layers within a dielectric material-filled space, it has the effect of facilitating slim manufacturing design of a product.

Second, since a notch forming part is provided to form the same single layer as a plurality of tuning bars of a frequency tuning panel and thus additional parts for skirt characteristics are not required, it is possible to prevent the weight of the product from increasing, thereby making it easy to design weight reduction.

### BRIEF DESCRIPTION OF THE DRAWINGS

FIG. 1 is a downward perspective view illustrating a filter for a communication device according to a first embodiment of the present disclosure.

FIG. 2 is an upward perspective view illustrating the filter for a communication device according to the first embodiment of the present disclosure.

FIGS. 3A and 3B are exploded perspective views of FIGS. 1 and 2, respectively.

FIG. 4 is a partial cut-away perspective view taken along line A-A of FIG. 1.

FIG. 5 is a perspective view illustrating a filter for a communication device according to a second embodiment of the present disclosure.

FIGS. 6A and 6B are a downward exploded perspective view and an upward exploded perspective view of FIG. 5.

FIG. 7 is a partial cut-away perspective view taken along line B-B of FIG. 5.

### DESCRIPTION OF REFERENCE SIGNS

100, 200: Filter for a communication device 110S,
210S: Dielectric material-filled space
110, 210: Filter body 117W, 217W: Space dividing rib
120, 220: Filter tuning cover correction hole
121: Tuning
122, 222: Tuning hole 125: Stepped part (spacer part)
130, 230: Resonance substrate 130F, 230F: Resonance frame
131, 231: Resonator(s) 140, 240: Frequency tuning panel
140F, 240F: Tuning frame 141, 241: Tuning bar(s)
142, 242: Notch forming part 143, 243: Coupling control bar
245: Stepped part (spacer part)

### BEST MODE

Hereinafter, a filter for a communication device according to embodiments of the present disclosure will be described in detail with reference to the attached drawings.

It is to be noted that in giving reference numerals to components of each of the accompanying drawings, the same components will be denoted by the same reference numerals even though they are illustrated in different drawings. Further, in describing exemplary embodiments of the present disclosure, well-known constructions or functions will not be described in detail in the case in which it is decided that they may unnecessarily obscure the understanding of exemplary embodiments of the present disclosure.

Terms ‘first’, ‘second’, A, B, (a), (b), and the like, will be used in describing exemplary embodiments of the present disclosure. These terms are used only in order to distinguish any component from other components, and features, sequences, or the like, of corresponding components are not limited by these terms. In addition, unless defined otherwise, all the terms used in the present specification, including technical and scientific terms, have the same meanings as meanings that are generally understood by those skilled in the art to which the present disclosure pertains. It should be interpreted that terms defined by a generally used dictionary are identical with the meanings within the context of the related art, and they should not be ideally or excessively formally interpreted unless the context clearly dictates otherwise.

Filters 100 and 200 for a communication device according to embodiments of the present disclosure includes filter bodies 110 and 210, and filter tuning covers 120 and 220 coupled to the filter bodies 110 and 210 to form dielectric material-filled spaces 110S and 210S between the filter bodies 110 and 210.

In the dielectric material-filled space 110S and 210S, a dielectric having a predetermined permittivity is filled. However, in the embodiments of the present disclosure, since air also corresponds to a dielectric material having a predetermined permittivity, it will be described assuming that the dielectric material-filled spaces 110S and 210S are filled with air as a dielectric. In this way, when air is adopted as a dielectric, it means that the dielectric material-filled spaces 110S and 210S, which are an empty space, are naturally filled with air as a dielectric unless the dielectric material-filled spaces 110S and 210S are in a sealed vacuum state, without a separate dielectric filling process.

Hereinafter, a filter for a communication device according to the present disclosure will be described in detail in order for each embodiment.

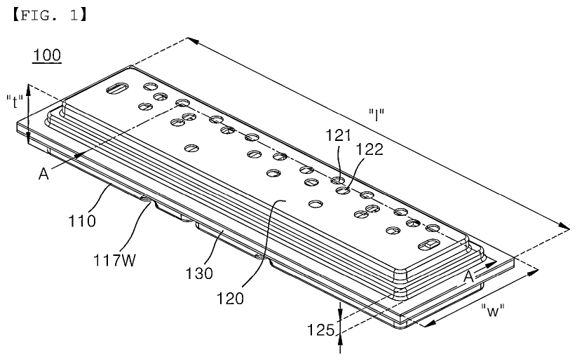

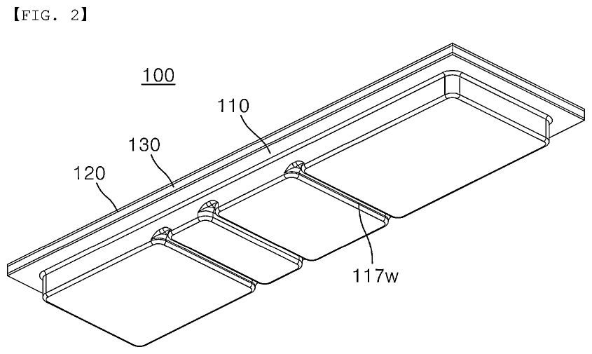

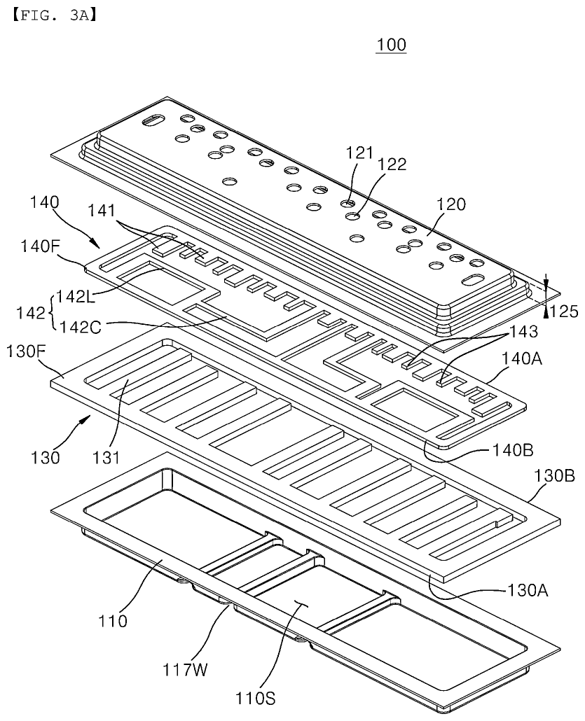

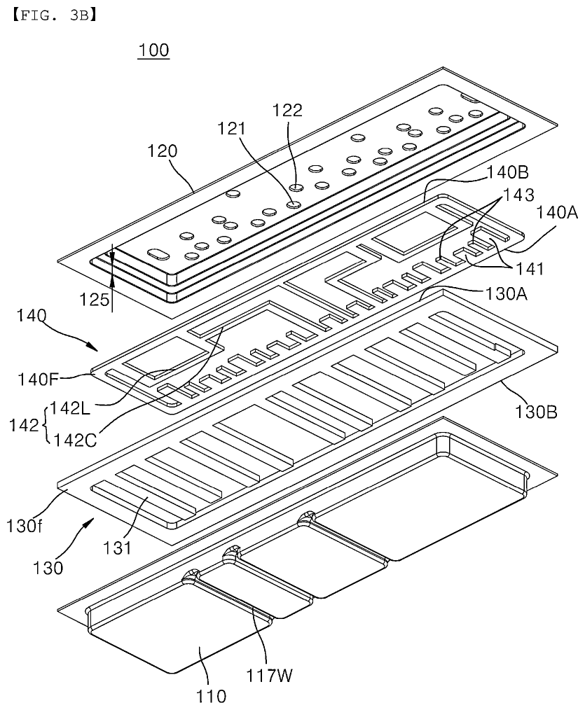

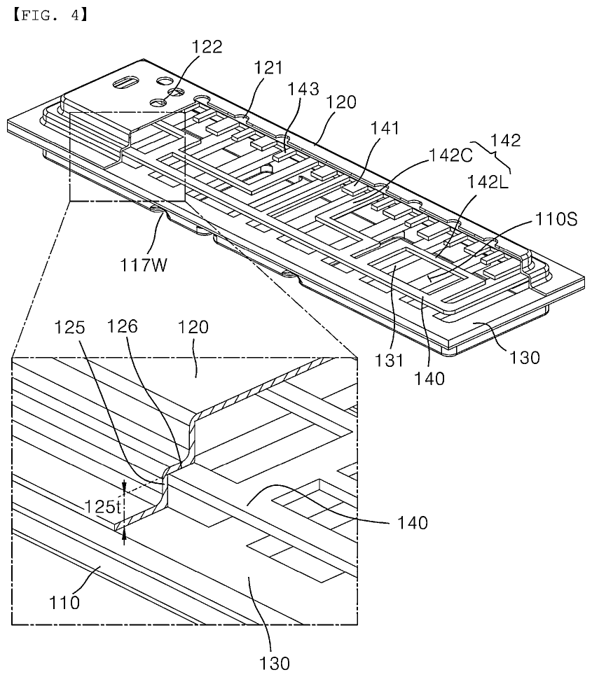

FIG. 1 is a downward perspective view illustrating a filter for a communication device according to a first embodiment of the present disclosure, FIG. 2 is an upward perspective view illustrating the filter for a communication device according to the first embodiment of the present disclosure, FIGS. 3A and 3B are exploded perspective views of FIGS. 1 and 2, respectively, and FIG. 4 is a partial cut-away perspective view taken along line A-A of FIG. 1.

Referring to FIGS. 1 to 4, the filter 100 for a communication device according to a first embodiment of the present disclosure may include, a filter body 110, a filter tuning cover 120 coupled to form the dielectric material-filled space 110S between the filter body 110, a resonance substrate 130 including the plurality of resonators 131 disposed to form a single layer in the thickness direction within the dielectric material-filled space 110S, and a frequency tuning panel 140 including a plurality of tuning bars 141 disposed to form a single layer in the thickness direction within the dielectric material-filled space 110S.

Referring to FIGS. 3A and 3B, the filter body 110 may be formed in a slim rectangular shape to form the closed dielectric material-filled space 110S having a thickness t that is approximately smaller than a length l and a width w.

Here, some of the dielectric material-filled space 110S may be formed by an open one side space of the filter body 110, and the rest of the dielectric material-filled space 10S may be formed by the other side space of the filter tuning cover 120.

To form the dielectric material-filled space 110S, the filter body 110 is provided in a form in which one side to which the filter tuning cover 120 is coupled collapses to a predetermined depth in a direction (downward in the drawing) toward the other side surface, and an inner side surface of the filter tuning cover 120 may also be provided in a form in which it collapses to a predetermined depth in the opposite direction (upward in the drawing).

The inside of the dielectric material-filled space 110S may be filled with a dielectric having a predetermined permittivity, but as described above, since air is also a type of dielectric having a predetermined permittivity, the first embodiment (the second embodiment described below is all the same) of the present disclosure is described assuming that a dielectric called air is filled.

Meanwhile, in the filter body 110, an input port hole and an output port hole (not illustrated) to which an input port and an output port (not illustrated) for inputting a predetermined signal to one side of the resonance substrate 130 to be described later are fixed may be through-formed so as to communicate with the dielectric material-filled space 110S.

Here, the input port and the output port may be electrically connected to the resonance substrate 130 so that impedance matching is maintained via the input coaxial connector and the output coaxial connector (not illustrated), respectively. However, the electrical connection with the resonance substrate 130 is not necessarily limited to the method using the input port and the input coaxial connector and the output port and the output coaxial connector, and if it is a conductive medium equipped on the main board (not illustrated), an electrical connection by any structure of electrical connection configuration such as a pin is possible.

The resonance substrate 130 is disposed as a single layer in the thickness direction t within the dielectric material-filled space 110S, and the plurality of resonators 131 are also formed as a single layer, and may include a resonance frame 30F having a rectangular edge.

Here, the resonance frame 130F may be formed to have edge portions that roughly matches edge end portions of the filter body 110 and the filter tuning cover 120.

Hereinafter, for the convenience of understanding, the resonance frame 130F is formed to communicate in the vertical direction by cutting the middle in a rectangular shape, and will be described assuming that it is formed in a rectangular shape extending from the left to the right in the drawings of FIGS. 3A and 3B. Since a left end and a right end in a length direction have relatively short sides, they are referred to as ‘short sides’, and since a front end and a rear end in a width direction have relatively long sides, they are referred to as ‘long sides’.

Here, referring to FIGS. 3A and 3B, the plurality of resonators 131 may be formed to extend a predetermined length from one long side 130A (hereinafter referred to as “one long side”) of the four sides (four sides) of the resonant frame 130F toward the other long side 130B (hereinafter referred to as “the other long side”).

However, it is preferable that the plurality of resonators 131 are formed so that their leading ends are not connected to an inner end of the edge of the other long side 130B described above.

In addition, the plurality of resonators 131 may be formed so that their leading ends have the same separation distance from the inner side end of the edge of the other long side 130B. However, extension starting points corresponding to one long side 130A of each of the plurality of resonators 131 do not have to be the same, and the extension starting points may be designed differently based on the frequency band pass characteristics required by the designer. That is, the extension starting points of each of the plurality of resonators 131 corresponds to the inner side end of the edge of any one long side 130A described above, and may be formed in a form that extends from the inner side end of the edge of the long side 130A to each extension starting point edge of the adjacent resonators 131.

Meanwhile, as illustrated in FIGS. 3A and 3B, the frequency tuning panel 140 may be disposed as a single layer between the resonance substrate 130 and the filter tuning cover 120.

More specifically, the frequency tuning panel 140 may include a tuning frame 140F having rectangular edges, and the plurality of tuning bars 141 extending from an inner side of one long side 140A to the other long side 140B side among the four sides (four sides) of the tuning frame 140F.

Here, the plurality of tuning bars 141 may be formed integrally with the tuning frame 140F. Preferably, the plurality of tuning bars 141 may be formed to extend integrally from the inner side of one long side 140A of the tuning frame 140F, but may be formed to extend by a predetermined length so as to form the same single layer in the thickness direction t of the dielectric material-filled space 110S.

Such a frequency tuning panel 140 may be disposed in a single layer different from the plurality of resonators 131 in the thickness direction t within the dielectric material-filled space 110S so as to adjust the separation of the plurality of tuning bars 141 from the plurality of resonators 131 disposed within the dielectric material-filled space 110S.

Here, the plurality of tuning bars 141 may be provided to be spaced apart from each other by a predetermined distance in the length direction 1 along an edge surface of the inside side of one long side 140A of the tuning frame 140F, and each tuning bar 141 may be disposed to be spaced apart from each other in the length direction 1 at positions matching each of the plurality of resonators 131 disposed to be spaced apart from each other in the thickness direction t within the dielectric material-filled space 110S.

Meanwhile, the plurality of tuning bars 141 may be set so that, unlike the above-described plurality of resonators 131 whose extension starting points are different, the extension starting points of the inner side of one long side 140A of the tuning frame 140F may all be set to the edge end of the inner side of the one long side 140A of the tuning frame 140F which is on the same line.

In addition, the leading ends of the plurality of tuning bars 141 may be set so that the leading ends of the abode-described plurality of resonators 131 are extended to have the same separation distance as the inner side end of the edge of the other long side 130B of the resonator frame 130F, but the lengths extending toward the other long side 140B each are the same or different.

However, in this case, since the plurality of tuning bars 141 are configured to perform fine frequency tuning by adjusting the separation distance t with the plurality of resonators 131 disposed in different single layers in the dielectric material-filled space 110S, it is preferable that the plurality of resonators 131 or the plurality of tuning bars 141 be designed to be disposed to overlap by at least a predetermined length in the thickness direction t of the dielectric material-filled space 110S.

In this case, when it is assumed that the dielectric filled in the dielectric material-filled space 110S is air, an air layer may exist between the plurality of resonators 131 of the resonance substrate 130 and an air layer with the same permittivity may also exist between the multiple resonators 131 and the inner surface of the filter body 110, and the fine frequency tuning may be performed through a slight change in the air layer according to the amount of shape deformation of each of the tuning bars 141 of the frequency tuning panel 140.

In addition, the filter 100 for a communication device according to the first embodiment of the present disclosure may further include a plurality of coupling control bars 143 that are integrally formed in the tuning frame 140F of the frequency tuning panel 140 as illustrated in FIGS. 3A and 3B and are shape-deformed toward the dielectric material-filled space 110S to change the coupling value between adjacent resonators 131 among the plurality of resonators.

Here, the plurality of coupling control bars 143 may be formed to extend from the inner side of one long side 140A of the tuning frame 140F to the other long side 140B, similar to the plurality of tuning bars 141 described above.

In this case, the plurality of coupling control bars 143 are formed to be spaced apart by a predetermined distance in the length direction 1 of the tuning frame 140F, and any one of the plurality of tuning bars 141 may be arranged between each coupling adjustment bar 143. That is, the plurality of tuning bars 141 and the plurality of coupling control bars 143 are formed to be integrally connected to the inner side of one long side 140A of the tuning frame 140F, but may be formed to be arranged alternately in the length direction 1 of the tuning frame 140F.

In addition, it is preferable that the plurality of coupling control bars 143 are arranged in an alternating manner with the plurality of resonators 131 with respect to the thickness direction t of the dielectric material-filled space 110S.

In this way, when a tuning worker (designer) pushes the leading end of one of the plurality of coupling control bars 143 toward the dielectric material-filled space 110S using the predetermined tool so that the coupling value desired by the tuning worker is implemented between adjacent resonators 131 among the plurality of resonators 131, the leading end of the coupling control bar 143 is positioned between the adjacent resonators 131 by deforming its shape, and depending on the specific shape of the C-notch part 142C or L-notch part 142L described below, the tuning worker can implement the coupling value as desired.

Meanwhile, in the filter 100 for a communication device according to the first embodiment of the present disclosure, as illustrated in FIGS. 3A and 3B, the frequency tuning panel 140 may further include the notch forming part 142 including an L-notch part 142L that protrudes and extends from the inner side of the other long side 140B to the one long side 140A among the four sides (four sides) of the tuning frame 140F while forming the closed loop and the C-notch part 142C that extends so as to be connected to the inner side of one long side 140A without forming a closed loop.

Here, the L-notch part 142L serves to form an L-notch according to inductive coupling at a right end of the passband by reinforcing the skirt characteristics, and the C-notch part 142C serves to form a C-notch according to capacitive coupling at a left end of the passband by reinforcing the skirt characteristics.

The L-notch part 142L may be provided to extend from the inner side of the other long side 140B of the frequency tuning panel 140 to form a single layer identical to the tuning bar 141 described above while simultaneously forming the closed loop that does not contact one long side 140A.

In addition, the C-notch part 142C may be provided to extend from the inner side of the other long side 140B of the frequency tuning panel 140 or the L-notch part 142L described above to be connected to one long side 140A while forming the single layer identical to the tuning bars 141 described above. Here, the C-notch part 142C has a difference in that, unlike the L-notch part 142L, it does not form a closed loop with respect to the other long side 140B within the same single layer.

The C-notch part 142C and the L-notch part 142L form an electric field (E-field) or a magnetic field (H-field) between the plurality of resonators 131 provided within the single layer, each having the same shape and the same shape of the corner or folded portion, thereby forming the C-notch or L-notch described above on the left or right side of the passband.

Meanwhile, referring to FIG. 3A and FIG. 3B, the C-notch part 142C among the C-notch part 142C and the L-notch part 142L may be formed by extending from the inner side end of the edge of the other long side 140B of the frequency tuning panel 140, and may also be formed by extending from a portion of the previously formed L-notch part 142L.

In addition, as described above, since the resonator 131 of the resonance substrate 130 and the tuning bar 141 of the frequency tuning panel 140 perform the fine frequency tuning by adjusting the separation distance in the thickness direction t, the structural design is required to secure a minimum separation distance.

To this end, the filter 100 for a communication device according to the first embodiment of the present disclosure may further include a spacer part (not indicated in the drawing) provided to secure a distance between the tuning bars 141 of the frequency tuning panel 140 and the resonators 131 of the resonance substrate 130.

Here, the spacer part may be formed as a stepped part 125 that may be formed integrally with the filter tuning cover 120 and may be formed so that an upper surface of an edge end portion of the frequency tuning panel 140 is joined and stacked at a position higher than a lower edge of the filter tuning cover 120 stacked on the upper surface of the resonance substrate 130.

More specifically, the spacer part may include the stepped part 125, which is provided to form a joint surface 126 on which the upper surface of the edge end portion of the frequency tuning panel 140 is joined as a different layer between the upper surface and the lower surface of the filter tuning cover 120, as illustrated in FIG. 4.

Here, it is preferable that the frequency tuning panel 140 is formed so that the size of the edge end corresponds to an outer side end of the joint surface 126 at the point where it is joined to the joint surface 126 corresponding to the horizontal plane of the stepped part 125. That is, the outer side end of the joint surface 126 may be formed at a position corresponding to the edge end formed by the tuning frame 140F of the frequency tuning panel 140.

Therefore, a height 125t of the stepped part 125 may be defined as a distance between the upper surface of the frequency tuning panel 140 stacked on the dielectric material-filled space 110S and the upper surface of the resonance frame 130F of the resonance substrate 130.

In this case, it is assumed that the upper surface of the edge end portion of the tuning frame 140F and the upper surfaces of the plurality of tuning bars 141 formed thereon are formed as a single layer having the same horizontal plane.

The stepped part 125 serves to block the direct contact between the plurality of tuning bars 141 of the frequency tuning panel 140 and the plurality of resonators 131 of the resonance substrate 130 and to form the air layer described above.

As another embodiment for forming a spacer (air layer) between the plurality of tuning bars 141 and the plurality of resonators 131, it is also possible to provide a spacer panel that is manufactured separately and stacked between the frequency tuning panel 140 and the resonance substrate 130, but the first embodiment 100 and the second embodiment 200 described below are concepts that exclude examples of separate manufacturing such as the spacer panel.

Here, blocking the direct contact between the frequency tuning panel 140 and the resonance substrate 130 by the spacer part means avoidance of physical space contact that forms the thickness to secure the separation distance, and does not mean blocking of electrical connection.

Such a spacer part performs a role of securing the above-described separation distance so that a desired passband frequency may be tuned by finely adjusting the separation distance T in the air layer that exists between the resonators 131 of the resonance substrate 130 and the tuning bars 141 of the frequency tuning panel 140.

More specifically, as illustrated in FIGS. 1 to 4, the dielectric material-filled space 110S between the filter body 110 and the filter tuning cover 120 is filled with the dielectric material defined as air, and the tuning designer inserts a predetermined tuning tool (not illustrated) into the inner side of the dielectric material-filled space 110S through the lower portion of the filter body 110 or the upper portion of the filter tuning cover 120, and then pushes the leading end of the resonators 131 to change its shape in the thickness direction t toward the tuning bar 141, or performs a fine frequency tuning operation by changing the leading end of the tuning bars 141 in the thickness direction t toward the resonators 131.

Here, a plurality of bottom tuning holes (not illustrated) for inserting the above-described tuning tool may be formed on the lower surface of the filter body 110 so as to be in communication with the dielectric material-filled space 110S, and the plurality of upper tuning holes 122 for inserting the above-described tuning tool may be formed on the upper surface of the filter tuning cover 120 so as to be in communication with the dielectric material-filled space 110S.

However, it is not necessary to have both the bottom tuning hole 122 and the upper tuning hole 122 in the filter body 110 and the filter tuning cover 120, and one of the two can be provided so as to function as a tuning hole into which the original tuning tool is inserted, and the other can be provided so as to function as a tuning correction hole for correction after tuning.

In addition, as illustrated in FIGS. 1 to 4, the filter body 110 may not be provided with the bottom tuning hole, and only the filter tuning cover 120 may be provided with the upper tuning hole 122 and the tuning modification hole 121. The tuning correction hole 121 may be a hole provided to readjust the deformed tuning bar 141 by inserting a separate tuning correction tool (not illustrated) when the correction is required after performing the fine frequency tuning using the tuning tool.

The filter for a communication device according to the first embodiment of the present disclosure having such a configuration sequentially stacks the filter body 110, the resonance substrate 130, the frequency tuning panel 140, and the filter tuning cover 120, so that the upper surface of the frequency tuning panel 140 is adhered to the lower surface of the joint surface 126, which becomes the horizontal plane of the stepped part 125, thereby securing a predetermined distance in the thickness direction t between the resonators 131 of the resonance substrate 130 and the tuning bars 141 of the frequency tuning panel 140.

Here, the filter body 110, the resonance substrate 130, the frequency tuning panel 140, and the filter tuning cover 120 may all be formed of a metal material, or formed of a predetermined dielectric material, and then formed so that the exposed portion toward the dielectric material-filled space 110S is entirely coated with a metal material. As long as the portion exposed toward the dielectric material-filled space 110S is coated with the metal material to form the dielectric material-filled space 110S as the closed space, as the stacked coupling method of the remaining components (resonance substrate 130, frequency tuning panel 140, and filter tuning cover 120) for the filter body 110, various coupling methods including a welding coupling method and an adhesive coupling method may be applied.

A specific passband frequency filtering process of the filter 100 for a communication device according to the first embodiment of the present disclosure configured as described above is briefly described as follows. This also applies to the filter 200 for a communication device according to the second embodiment described below, so its specific description is omitted in the description of the second embodiment 200.

First, when a predetermined signal is input to the dielectric material-filled space 110S through the input port on one side, it is sequentially transmitted in the length direction 1 through the resonator 131 of the resonance substrate 130 connected through the input coaxial connector of the input port in the dielectric material-filled space 110S, and is output through the resonator: 131 of the resonance substrate 130 connected to the output coaxial connector of the output port in the dielectric material-filled space 110S.

In this case, only a specific bandpass frequency may be output according to the fine frequency tuning by the detailed design of the separation distance of the upper and lower thickness direction t of each resonator 131 and the tuning bar 141.

Here, according to the filter 100 for a communication device according to the first embodiment of the present disclosure, the extension formation direction of the resonator 131 is provided to form the single layer in the thickness direction t within the dielectric material-filled space 110S, and the tuning bar 141 is also provided to form the single layer in the thickness direction t different from that of the resonator 131 within the dielectric material-filled space 110S, thereby enabling slim manufacturing of the overall product thickness and providing the advantage of enabling the fine frequency tuning within the distance limit of each single layer in the different thickness directions t described above.

Meanwhile, referring to FIGS. 1 to 4, the filter 100 for a communication device according to the first embodiment of the present disclosure may further include a plurality of space dividing ribs 117W that do not completely divide the dielectric material-filled space 110S, but at least partially divide a bottom portion of the dielectric material-filled space 110S formed by the filter body 110.

The plurality of space dividing ribs 117W may be formed to extend from the bottom surface of one long side to the bottom surface of the other long side so as to divide the bottom surface portion of the inner side of the filter body 110 formed in the length direction 1 into a plurality of surfaces, but may be formed in the form of ribs protruding by a predetermined length from at least the bottom surface of the dielectric material-filled space 110S toward the filter tuning cover 120.

The plurality of space dividing ribs 117W occupy a part of the dielectric material-filled space 110S and divide at least the space between the resonators 131 into cavities, thereby providing an advantage of tuning various passband frequencies by controlling the amount of coupling between adjacent resonators 131 according to the size or shape of the occupied space.

In addition, the filter body 110 may be coupled so that the entire bottom surface is soldered to the main board side (not illustrated), and as the plurality of space dividing ribs 117W divide the bottom surface of the filter body 110 in the length direction 1, it may also play a role in dispersing and relieving thermal stress caused by a difference in thermal expansion coefficient with the main board, which is a PCB material.

As illustrated in FIGS. 1 to 4, it is described already that the filter 100 for a communication device according to the first embodiment of the present disclosure may include the L-notch part 142L that implements inductive coupling and the C-notch part 142C that implements capacitive coupling, by utilizing electric and magnetic field properties between each of the resonators 131 provided within the dielectric material-filled space 110S.

The inductive coupling is a type of coupling using magnetic field properties around the resonators 131 provided in the dielectric material-filled space 110S. The inductive coupling is a coupling that is naturally formed in the absence of the structure that affects a magnetic field property between adjacent resonators 131. Particularly, in the case of implementing the cross-coupling that crosses the resonator provided in the middle among arbitrary three resonators 131, the meaning including the above-described L-notch part 142L may be greater. Here, in the case of the filter 100 for a communication device according to the first embodiment of the present disclosure, the L-notch part 142L may be provided so as not to block the signal transmission path between the leading ends of the adjacent resonators 131, but may be provided so as to have a portion closer than the resonator provided in the middle among any three resonators 131.

Meanwhile, the capacitive coupling is a type of coupling that utilizes the electric field properties around the resonators 131 provided in the dielectric material-filled space 110S, and may be implemented by a structure arranged on the signal transmission path corresponding to the electric field of the adjacent resonators 131.

More specifically, the C-notch part 142C is formed to be connected by extending from the other long side 140B to one long side 140A of the frequency tuning panel 140, and is involved in any three resonators 131 of the dielectric material-filled space 110S. In this case, the starting end and the leading end of the C-notch part 142C may be designed to be arranged closer than the middle resonator of the any three resonators 131, respectively.

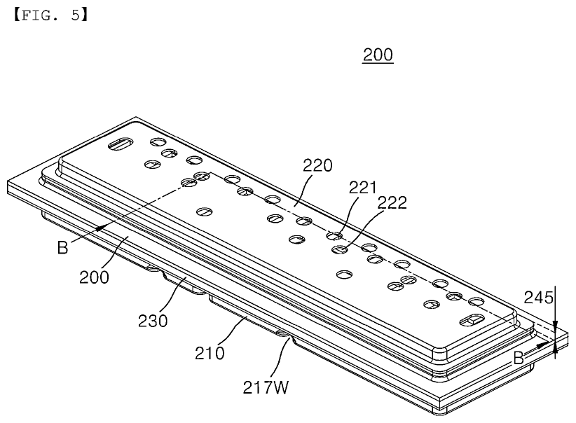

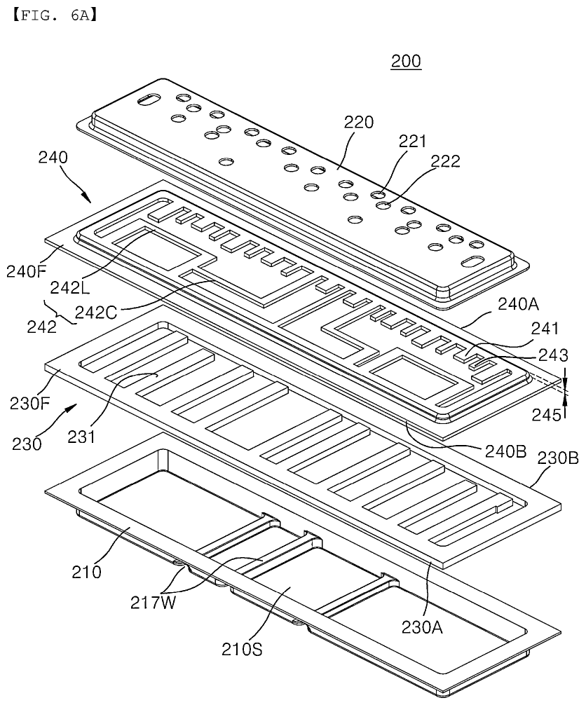

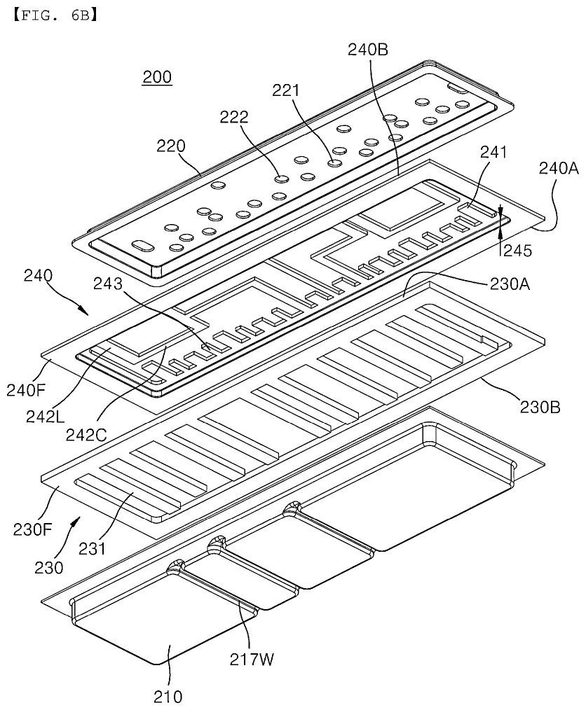

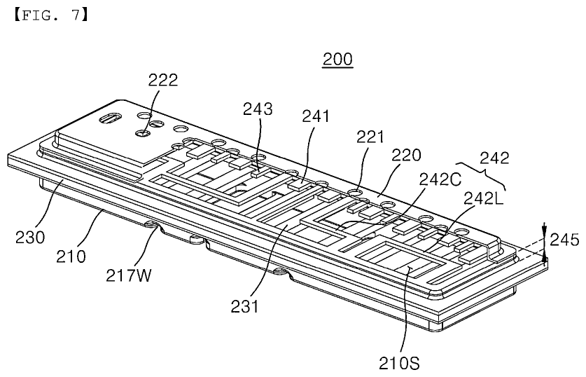

FIG. 5 is a perspective view illustrating a filter for a communication device according to a second embodiment of the present disclosure, FIGS. 6A and 6B are a downward exploded perspective view and an upward exploded perspective view of FIG. 5, and FIG. 7 is a partial cut-away perspective view taken along line B-B of FIG. 5.

Hereinafter, the filter 200 for a communication device according to the second embodiment of the present disclosure has the same configuration as the filter 100 for a communication device according to the first embodiment described above, except for the spacer part for securing a distance in the thickness direction t between the resonators 231 of the resonance substrate 230 and the tuning bars 241 of the frequency tuning panel 240.

In the filter 200 for a communication device according to the second embodiment of the present disclosure, as illustrated in FIGS. 5 to 7, the spacer part may be formed as the stepped part 245 that is integrally formed with the frequency tuning panel 240, so that the edge end portion (more specifically, the edge end portion of the tuning frame 240F) of the frequency tuning panel 240 stacked on the edge upper surface of the resonance substrate 230 is lower than the plurality of tuning bars 241.

More specifically, in the case of the filter 100 for a communication device according to the first embodiment, as illustrated in FIGS. 6A and 6B, the tuning frame 240F of the frequency tuning panel 240 and the plurality of tuning bars 241 formed therein are all formed on the same layer, whereas in the filter 200 for a communication device according to the second embodiment, the stepped part 245 is formed to be stepped so that the tuning frame 240F of the frequency tuning panel 240 is formed in a different layer from the plurality of tuning bars 241.

Here, the end portion of the filter tuning cover 220 may be stacked and joined to the upper surface of the stepped part 245 as the same layer as the plurality of tuning bars 241, as illustrated in FIG. 7.

Therefore, the height of the stepped part 245 may be defined as the distance between the lower surface of the filter tuning cover 220 and the upper surface of the tuning frame 240F of the frequency tuning panel 240.

In this way, the filter 200 for a communication device according to the second embodiment of the present disclosure is integrally formed on the frequency tuning panel 240 unlike the spacer part integrally formed on the filter tuning cover 120 in the first embodiment 100, performs the same function in that it secures a predetermined separation distance to form an air layer between multiple resonators 131 and 231 and multiple tuning bars 141 and 241, and enables the adjustment of the fine frequency, thereby enabling the manufacturing of slim products and enhancing skirt characteristics through the notch forming part.

Hereinafter, the filter for a communication device according to embodiments of the present disclosure will be described in detail with reference to the attached drawings. However, it should be taken for granted that the embodiments of the present disclosure are not necessarily limited by the above-described embodiments, and various modifications and implementation within the equivalent range are possible by those skilled in the art to which the present disclosure belongs. Therefore, it will be said that the true scope of the present disclosure is determined by the claims described later.

### INDUSTRIAL APPLICABILITY

The present disclosure provides a filter for a communication device that includes a tuning panel having a plurality of tuning bars disposed as a single layer in a thickness direction within a dielectric material-filled space, and can perform frequency tuning by adjusting a separation distance between a plurality of resonators of a resonance substrate disposed as a single layer different from the tuning panel in the thickness direction within the dielectric material-filled space, and includes a notch forming part formed as the same single layer as the tuning panel.

1. A filter for a communication device, comprising:
a filter body that is opened in a thickness direction and forms a portion of a dielectric material-filled space therein;
a filter tuning cover that is coupled in the thickness direction so as to cover the filter body and forms the rest of the dielectric material-filled space;
a resonance substrate that includes resonance frame in which a plurality of resonators are disposed to form a single layer in the thickness direction within the dielectric material-filled space;
a frequency tuning panel that includes a tuning frame having a plurality of tuning bar disposed as a single layer in the thickness direction within the dielectric material-filled space to adjust a separation distance between a plurality of resonators disposed within the dielectric material-filled space; and
a spacer part that is integrally formed to be stepped with one of the filter tuning cover and the frequency tuning panel.

2. The filter of claim 1, wherein the spacer part is provided to secure a separation distance between the plurality of resonators and the plurality of tuning bars.

3. The filter of claim 1, wherein the spacer part is formed as a stepped part that is integrally formed with the filter tuning cover and is formed so that an upper surface of an edge end portion of the frequency tuning panel is stacked at a position higher than a lower edge of the filter tuning cover stacked on an upper surface of the resonance substrate.

4. The filter of claim 3, wherein the spacer part includes the stepped part so as to form a joint surface where the upper surface of the edge end portion of the frequency tuning panel is joined as a different layer between the upper surface and the lower surface of the filter tuning cover.

5. The filter of claim 4, wherein an outer side end of the joint surface is formed at a position corresponding to the edge end of the frequency tuning panel.

6. The filter of claim 4, wherein a height of the stepped part is the separation distance between the upper surface of the frequency tuning panel stacked on the dielectric material-filled space and the upper surface of the resonance frame of the resonance substrate.

7. The filter of claim 3, wherein the upper surface of the edge end portion of the tuning frame and the upper surfaces of the plurality of tuning bars are formed as a single layer having the same horizontal plane.

8. The filter of claim 1, wherein the spacer part is formed as a stepped part that is integrally formed with the frequency tuning panel and is stepped so that an edge end portion of the frequency tuning panel stacked on an edge upper surface of the resonance substrate is lower than the plurality of tuning bars.

9. The filter of claim 8, wherein the stepped part is formed to be stepped so that the plurality of tuning bars and the tuning frame form different layers.

10. The filter of claim 8, wherein the end portion of the filter tuning cover is stacked and joined to the upper surface of the stepped part as the same layer as the plurality of tuning bars.

11. The filter of claim 8, wherein the height of the stepped part is the separation distance between the lower surface of the filter tuning cover and the upper surface of the tuning frame.

12. The filter of claim 1, further comprising:
a plurality of coupling control bars that are integrally formed with a tuning frame of the frequency tuning panel and are shape-deformed in the direction of the dielectric material-filled space to change a coupling value between adjacent resonators among the plurality of resonators.

13. The filter of claim 12, wherein the plurality of coupling control bars are alternately disposed with the plurality of resonators in the thickness direction of the dielectric material-filled space.

14. The filter of claim 12, wherein the plurality of coupling control bars are formed so as to be arranged alternately with the plurality of tuning bars in a length direction of the tuning frame.
